(19) United States
(12) Patent Application Publication
(10) Pub. No.: US 2005/0140668 A1
(43) Pub. Date: Jun. 30, 2005

(54) Ingeeni flash interface

(76) Inventors: Michal Hlavac, Cambridge, MA (US); Senia Maymin, Belmont, MA (US); Milos Hlavac, Senningerberg (LU); Cynthia Breazeal, Cambridge, MA (US); Juraj Hlavac, Seattle, WA (US); Dennis Bromley, University City, MO (US)

Correspondence Address: Mark J. Pandiscio;Pandiscio & Pandiscio, P.C., 470 Totten Pond Road, Waltham, MA, 02451-1914, US

(21) Appl. No.: 10/836,557

(22) Filed: Apr. 30, 2004

Related U.S. Application Data
(60) Provisional application No. 60/532,969, filed on Dec. 29, 2003.

(51) Int. Cl. G06T 15/00

(52) U.S. Cl. 345/419

(57) ABSTRACT

A method for presenting graphics to a user is disclosed, the method comprising providing a 3D graphics system comprising a 3D graphics environment and at least one virtual object positioned in the 3D graphics environment, providing a 2D graphics rendering engine configured to use 2D mathematics, and providing a library of sprites for use by the 2D graphics rendering engine, selecting a camera perspective within the 3D graphics environment, based on the selected camera perspective, generating an appropriate 2D view of the 3D graphics environment, based on the generated 2D view, selecting an appropriate sprite and, for that sprite, the appropriate rendered view for that sprite, determining the appropriate screen location and scale for the selected rendered view for the sprite, and instructing the 2D graphics rendering engine to paint the selected rendered view for the sprite to the determined screen location and with the determined scale.

### REFERENCE TO PENDING PRIOR PATENT APPLICATIONS

This patent application claims benefit of pending prior U.S. Provisional Patent Application Ser. No. 60/532,969, filed Dec. 29, 2003 by Michal Hlavac et al. for INGEENI FLASH INTERFACE (Attorney's Docket No. INGEENI-4 PROV), which patent application is hereby incorporated herein by reference.

### FIELD OF THE INVENTION

This invention relates to computer graphics in general, and more particularly to a novel system for presenting 3D graphics using a 2D graphics rendering engine. Among other things, the present invention may be applied to computer graphics systems for presenting animated characters and the like.

### BACKGROUND OF THE INVENTION

In many situations, it may be desirable to present images of 3D objects on a television or computer screen. These 3D objects may comprise substantially any type of object, including real objects and imaginary objects.

One type of object which may be presented is that of animated characters.

Inasmuch as the present invention is particularly well suited to the presentation of animated characters, the following description will be delivered in the context of presenting such animated characters. However, it should be appreciated that this is solely for the sake of example and not limitation. The present invention is applicable to the presentation of substantially any type of object.

### Status Quo—How Graphics Work In 3D

### Overview

Currently, 3D graphics systems work in the following manner. First, all 3D graphical information (including colors, geometries, textures, and lighting) is conveyed as a scene graph of (x, y, z) coordinates. Secondly, before displaying the 3D information onto a computer screen, a perspective transformation is applied, which essentially means that all 3D information is changed into 2D information. Finally, rasterizing translates the resulting coordinates to screen pixels.

### Scene Graph

A scene graph is composed of nodes. All graphical information in the scene graph is traversed some number of times per second (e.g., 30 times per second). Each node contains information about the transform from the original node (T), the material used to color that node (M), the geometry of polygons around that node (G), the texture used on that node (X), and the lighting shading that node (L).

For example, where the 3D object comprises an animated character, the animated character is typically animated by a series of nodes traversed throughout the character body from the original node.

The scene graph is all the information above (including but not limited to T, M, G, X, and L) held in a data structure of (x, y, z) coordinates. This mathematical information is updated some number of times per second to reflect any movement in the animated character.

### Perspective Transform

The 3D information must be converted to 2D information in order to be shown on a 2D TV or computer screen. This conversion is called a perspective transform or camera transform. This transform accounts for the perspective difference in moving from 3D to 2D. The transform occurs as if a certain angle, often called a field of view, is chosen and the entire on-screen world is seen from this angle. This allows the 2D information to be interpreted from the 3D information, taking into account perspective.

### Rasterizing

The final step in showing an image on screen is rasterizing. Rasterizing is the process of converting the final information and putting it onto a computer screen.

### Some Disadvantages of 3D Graphics Systems

3D graphics systems of the type described above are preferred in many applications, inasmuch as they provide a robust graphics environment able to produce highly realistic images. Unfortunately, however, such 3D graphics systems also have some significant disadvantages associated with them, including computational requirements, large file size, etc. Some of these disadvantages can become prohibitive where data must be transferred across a network (e.g., the Internet) and images rendered on a client computer, particularly where the client computer may have a relatively slow network connection and/or limited processing power.

As a result, some 2D graphics systems have been developed which may be used even where there is a relatively slow network connection and/or limited client processing power. Macromedia's Flash system is an example of one such system which is currently in widespread use. With the Flash system, a Flash player is installed on the client computer and relatively modest data files must be sent over the network. Unfortunately, the Flash system is based on 2D graphics, which generally provides a less robust user experience than 3D graphics.

### SUMMARY OF THE INVENTION

Ingeeni has created a novel system for creating a 3D look in 2D, so as to provide the visual appeal of 3D graphics with the bandwidth and processing overhead of 2D graphics.

More particularly, Ingeeni has created an interface which sits between a 3D graphics system and a 2D graphics system, whereby to permit the creation of a virtual world in 3D graphics which is then converted to 2D graphics for transmission over a network and rendering on a client computer so as to provide the appeal of 3D-looking graphics systems.

In one preferred form of the invention, the Ingeeni interface is configured for use with Macromedia's Flash player, with the Ingeeni interface being implemented as a C++ application on top of Macromedia's Flash player. This interface is hereinafter sometimes referred to as the Ingeeni FlashAdapter. The communication is implemented using Macromedia's C++ API, in particular, the setVariable( ) method.

The Ingeeni FlashAdapter interface is preferably characterized by the following features:
(1) Contains 3D scene graph. (
2) Perspective transform is computed. 3D coordinates (x, y, z) are translated into 2D (x, y, scale) and a SmartSprite (see below) index.
(3) SmartSprite—an array of rendered views of the sprite, based on horizontal/vertical angle. The sprite can also be animated.
(4) SmartSprite index—an index into the array of pre-rendered sprites. In order to compute the index, it is often best to use screen coordinates (this is the LookAt( ) example).
(5) The SmartSprite graphics can be interpolated.
(6) The 2D information (xscreen, yscreen, scale, SmartSprite index) is used to place the relevant piece of 2D graphics (a Flash movie) in the correct place on the screen.
(7) The 2D application renders the changes.

See FIG. 1.

This novel approach permits both C++ and Flash to be used for what they do best:
(a) C++ is used to execute the computationally expensive 3D math (floating point number multiplies as a part of computing the 3D matrix math).
(b) The 2D Flash engine is used for drawing 2D primitives, a task it has been designed and optimized for.
(c) The 3D scene graph is used to manipulate pre-rendered sprites, not traditional polygonal graphics.
(d) Arrays of pre-rendered animated sprites are used to paint complicated graphics objects (e.g., a head, a hand, etc.)
(e) Interpolation is used between the sprites.
(f) A combination of all the techniques above is used to deliver fast, 3D-looking graphics, optimized for Web delivery.

### BRIEF DESCRIPTION OF THE DRAWINGS

These and other objects and features of the present invention will be more particularly disclosed or rendered obvious by the following detailed description of the preferred embodiments of the invention, which is to be considered together with the accompanying drawings wherein like numbers refer to like parts and further wherein:

FIG. 1 is a schematic view of a novel system implementing the present invention;

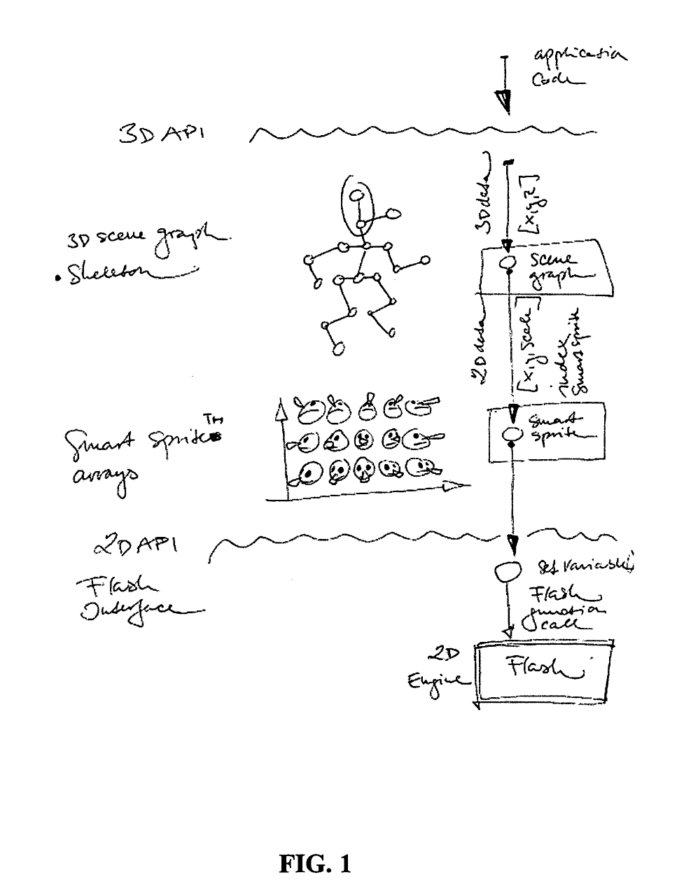

FIG. 2 is a schematic view of a flow diagram showing the dialogue between the Ingeeni FlashAdapter and the Flash player; and

FIG. 3 is a schematic view illustrating rotational jitter correction for the present invention.

### DETAILED DESCRIPTION OF THE PREFERRED EMBODIMENTS

### NEW—How the Ingeeni Solution Works

As noted above, the present invention relates to an adapter which sits between a 3D graphics system and a 2D graphics system so as to provide the best advantages of each system.

As also noted above, one such 2D system currently in widespread use is the Macromedia Flash system.

Inasmuch as the present invention is particularly well suited to use with the Macromedia Flash system, and inasmuch as the Macromedia Flash system is currently in widespread use, the following description will be delivered in the context of the Macromedia Flash system. However, it should be appreciated that this is solely for the sake of example and not limitation. The present invention is also applicable to use with many other 2D graphics systems.

Ingeeni has created the FlashAdapter to sit as an interface between a 3D graphics system and the Flash player. The following is a description of how the Ingeeni FlashAdapter sets up the communication channel on both the Flash side and the C++ side.

### General Concept

The Macromedia Flash player has a COM interface that exposes some of the basic functionality of Flash. It generally contains simple functions, such as play( ), stop( ), rewinds, and so on. For full documentation on the Flash player interface, refer to the Macromedia website at http://www.macromedia.com/support/flash/publishexport/scriptingwithflash/.

The Macromedia Flash player interface is geared towards using the interface in JavaScript, but the set of exposed functions and their use is identical to what the Ingeeni Player sees and uses in C++.

The problem with the exposed Flash interface is that it does not expose functions to create new Flash symbols, move them around, scale them, or hide them. It does expose properties of symbol objects (Flash movies) which, in theory, would make these manipulations possible. However, in practice, Flash does not do a good job of allowing one to write into the properties that the interface exposes and have those properties have much effect on the Flash symbols themselves.

The inventors have found that the only reliable method of passing information into Flash is using the SetVariable( ) function to write into actual Flash script variables, rather than writing into the properties of Flash objects.

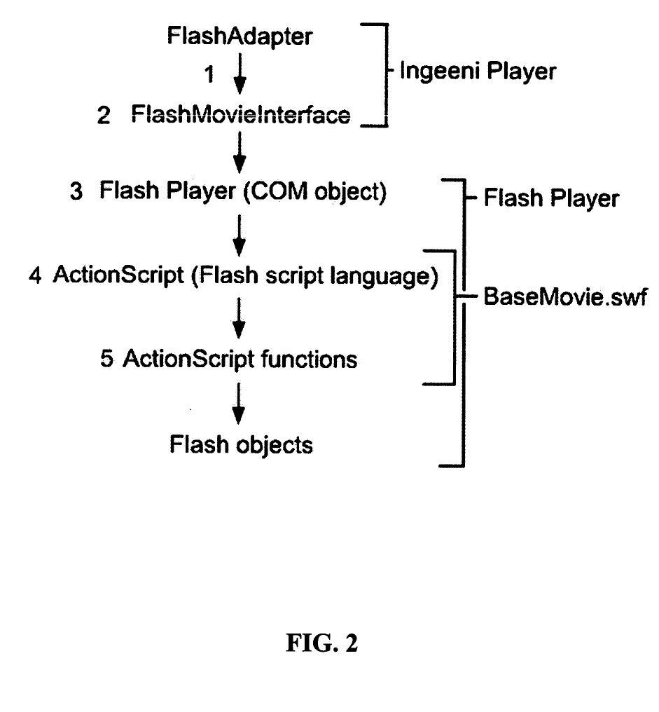

So, in order to talk to Flash, the Ingeeni FlashAdapter employs the following model (see also FIG. 2):
(1) The FlashMovieInterface class exposes an interface that allows the Ingeeni FlashAdapter to directly create Flash symbols, move them around, scale them, and so on.
(2) The FlashMovieInterface class takes the commands from above and translates them into a set of SetVariable( ) function calls into the Flash Player COM object.
(3) The Flash Player, executing the SetVariable( ) function calls, sets the appropriate global ActionScript variables in the Flash SWF movie.
(4) The Flash ActionScript in the base SWF movie is instrumented with triggers that go off when certain key global variables change their values, and that execute more complex ActionScript functions.
(5) The ActionScript functions that get “woken up” by the variable triggers use the ActionScript set of commands to manipulate the actual Flash objects in the movie (move, scale, create, . . . ). The details of the translation in step (2), and its reverse in step (5), is discussed in detail in the sections below.

### The Details

### Flash BaseMovie.swf

Each base movie to be used by the Ingeeni FlashAdapter (such as BaseMovie.swf) needs to have the following two pieces:
(1) A bit of ActionScript at the frame where the interaction with the C++ code should be taking place (typically frame 0). The script should do the following two things:
   (i) include the “ExternalInterface.as” file that essentially contains the definition of the ExternalInterface class we use in Flash; and
   (ii) create an instance of the ExternalInterface class and specify its name in a global variable. For the purposes of all the examples in this document, the instance name of the ExternalInterface class is given the name ‘ei’.
(2) Create a dummy symbol that is used to load all the other symbols.

Details of how the aforementioned two pieces need to be set up can be found in the following section entitled “Practicalities—How To Make It Work”

Any movie can be made to act as the base movie for the interaction, but it can sometimes be easier to take a template that already exists, copy it, and modify it as needed.

### C++ to Flash

Each function call from the Ingeeni FlashAdapter into the FlashMovieInterface is translated into SetVariables calls that have the following pattern:

| | |
|---|---|
| SetVariable(“ei.fnCurrent.fnName”, “addActor”); | name of the function |
| | to execute |
| SetVariable(“ei.fnCurrent.param0”, “myActor”); | first function |
| | parameter |
| SetVariable(“ei.fnCurrent.param1”, 2); | second function |
| | parameter |
| SetVariable(“ei.w_execute”, 1); | execution trigger |

This particular example adds an empty actor of the name “myActor” at depth 2 on the stage. Suppose it is desired to not only add an actor but also position it in the same batch of commands (so that both of these commands can be executed between frame renders, for example), here is how it may be done:

| | |
|---|---|
| SetVariable(“ei.fnCurrent.fnName”, “addActor”); | name of the |
| | function to execute |
| SetVariable(“ei.fnCurrent.param0”, “myActor2”); | param1 |
| SetVariable(“ei.fnCurrent.param1”, 3); | param2 |
| SetVariable(“ei.w_addToBatch”, 1); | another command |
| | is coming |
| SetVariable(“ei.fnCurrent.fnName”, “moveActor”); | name of the function |
| | to execute |
| SetVariable(“ei.fnCurrent.param0”, “myActor2”); | param1 |
| SetVariable(“ei.fnCurrent.param1”, 100); | param2 |
| SetVariable(“ei.fnCurrent.param2”, 100); | param3 |
| SetVariable(“ei.fnCurrent.param3”, 50); | param4 |
| SetVariable(“ei.fnCurrent.param4”, 50); | param5 |
| SetVariable(“ei.w_execute”, 1); | trigger the execution |

This set of calls not only adds an actor of name myActor2, but also moves it to position (100, 100) and scales it to (50%, 50%).

All Flash variables beginning with “w_”, such as “w_addToBatch” and “w_execute” in the example above, are being “watched” and any value assignment to them triggers a function call. Setting “w_addToBatch” to any value, for example, causes some variable shuffling on the Flash side, such that another function can be added to the function queue. Setting “w_execute” to any value, on the other hand, causes the batch of function calls queued on the Flash side to be executed.

### Flash to C++

Flash also needs a way to communicate back to C++. The Flash player is the source of user events, such as mouse movement and key strokes, and those events need to be sent back to the Ingeeni Player for processing. Fortunately, sending information in this direction (i.e., Flash to the Ingeeni adapter) is considerably simpler than in the opposite direction (i.e., the Ingeeni adapter to Flash).

Flash has an ActionScript command called fscommand( ) that broadcasts a COM event that can be easily caught in the Ingeeni Player. This COM event has two parameters associated with it: a “command” and an “argument”, although they literally translate to two strings that can contain any data which is inserted there. For the purposes of the Ingeeni FlashAdapter, the first string is used to identify the nature of the event (e.g., mouse movement, render event, etc.) and the second string is used to transmit any data that comes along with it (e.g., coordinates, value of the key pressed, etc.). So, for example, when the user moves a mouse, the ExternalInterface class in Flash calls the following command:

fscommand(“mousemove”, “123,56”); // new x,y coordinates

This indicates that the mouse has moved to the base movie coordinates (123, 56).

### Practicalities—How to Make it Work

Design aside, there are very specific steps that need to take place in order for the FlashMovieInterface to be able to communicate with a Flash movie. Basically, the following needs to happen:

(1) The Flash movie must include the following lines of ActionScript in its resting frame (the frame where it ends up in and stays for the rest of the interaction—presumably this is the first frame since the main timeline will generally only have a single frame):

#include “ExternalInterface.as”
var MyInterface = new ExternalInterface( );
g_EXTERNAL_INTERFACE_INSTANCE = “MyInterface”;

This piece of ActionScript includes the ExternalInterface class definition, instantiates it, and lets the FlashMovieInterface in C++ know the name of the instance (through the use of the global variable above).
(2) A movie clip symbol needs to be manually created and a piece of ActionScript added to it. To do so, these steps may be followed:
   (a) In the Flash editor, go to the menu “Insert/New Symbol . . . ”;
   (b) For the name, type “MovieLoader”;
   (c) Make sure behavior is selected to “Movie Clip”;
   (d) In the absence of any more settings, click the “Advanced” button;
   (e) Under linkage, click “Export for ActionScript” and hit OK;
   (f) This should enter the new MovieClip; go to menu “Window/Actions”;
   (g) Click on frame 1 in the timeline; the ActionScript window should now say “Actions for Frame 1 of Layer Name Layer 1”;
   (h) Copy the following ActionScript into the ActionScript window:
      this.createEmptyMovieClip(“EI_PlaceHolder”, 1);
      this.EI_PlaceHolder.loadMovie(filename);
   (i) Done. Click on “Scene 1” underneath the movie timeline to get back into the main timeline.

Alternatively, the name “EI_PlaceHolder” can be replaced with something more compact, such as “x”, but back in the ActionScript for the main timeline of the movie, exactly where the ExternalInterface class is instantiated, the global variable g_EXTERNAL_INTERFACE_MOVIE_PLACE_HOLDER also needs to be modified and set it equal to “x”, like this:
g_EXTERNAL_INTERFACE_MOVIE_PLACE_HOLDER=“x”;
(3) The process is completed! The only other trick is that any .swf movie that is to be imported as an actor, as well as the HTML that hosts the interaction, all need to live in the same directory or the same external server as this base Flash movie. This is IMPORTANT. Otherwise the actors will not be displayed when they are created. Apparently this restriction is here as a security feature of Flash.

In various forms of the invention, similar steps may be used to achieve the same effect.

### Testing the Ingeeni Solution

This is a basic overview of the Ingeeni AdapterDebugger tool, defines its use, and suggests possible extensions. This is a description of the Ingeeni AdapterDebugger, which tests the Ingeeni FlashAdapter.

### General Idea

Initially, this tool was designed to test some of the specific functionality of the Ingeeni FlashAdapter class and catch its bugs in simple and reproducible cases. However, it has also been found to be useful as a tool to check and “tweak” the correctness of FLing files as well. Basically, it places a UI on top of the GFXAdapter API and, specifically, hooks it up to the Ingeeni FlashAdapter. Hence, it allows the creation of actor objects, moves them around, starts and stops actions on them, and switches between all available cameras.

The way it works is that there is a separate DLL, called AdapterDebugger.dll, that contains an ActiveX control used on an HTML page, called AdapterDebugger.html. That page has a large amount of JavaScript UI that calls into the ActiveX control and that, in turn, calls into the GFXAdapter class. This could be either Ingeeni FlashAdapter or WTAdapter, depending on whether the Flash player or the WT player have been embedded in AdapterDebugger.html. So, theoretically, one could take the AdapterDebugger.html, embed the WT player object into it instead of the Flash player object, simply by switching one of the <OBJECT> tags on the page and then you have the same HTML page testing the WTAdapter instead of the Ingeeni FlashAdapter.

Finally, all files relevant to the Web page hosting the Ingeeni AdapterDebugger control, as well as the Web page itself, are also included in the Ingeeni AdapterDebugger project for easy editing. They are grouped under the “Web Page Data” project directory in the Solution Explorer.

### Setup

To run the Ingeeni AdapterDebugger, first either an already existing AdapterDebugger.dll needs to be registered (this only has to be done once) using regsvr32.exe or the AdapterDebugger project must be built from within Visual Studio, which will then build and register the DLL. To do the latter, open up IngeeniComponents solution in VS, right click on the “AdapterDebugger” project in the Solution Explorer, select it as the StartUp Project, and select Build/Build Solution from the menu.

After this step, all that needs to be done is to open up AdapterDebugger.html in a Web browser.

### User Interface

The Ingeeni AdapterDebugger should be relatively easy to use, since all it really does is provide a UI to access the functionality of the GFXAdapter interface. Refer to the Examples.doc document that outlines some of the most common workflows.

### Creating an Actor

To create an actor, a FLing file must be loaded that defines it. Click on the “Create” tab in the UI and specify the path to the actor files, the actor file name, and the instance name. When “Create Actor” is clicked, the GFXAdapter tries to load:
<actor path>\<actor name>\flash\<actor name>.FLing
   If the file does not exist, an assert will be generated. If the file does exist, but cannot be parsed, an error will be generated saying so. If all goes well, a message will be generated saying “Actor created successfully”. The given actor will have the instance name specified. Each actor's instance name needs to be unique.

When an actor loads successfully, the various actor, node, camera, and action drop-downs get pre-populated with the names of the various components.

### Displaying an Actor

To display an actor that has been loaded, two things are needed:
(1) Click on the “Cameras” tab and select one of the available cameras from the list. If none of the loaded actors contain cameras, this list will be empty and the scene cannot be viewed. Otherwise, all cameras of all actors loaded in the scene will be shown. Select the desired one and click on the “Activate Camera” button.
(2) If the actor does not specify an action or a set of actions to start automatically when the actor loads, it will be necessary to start one manually. To do so, click on the “Actions” tab. Select the appropriate actor from the drop-down above the tabs. If the selected actor has any actions associated with it, they will appear in the action drop-down. Select the appropriate action and click on the “Start Action” button.

### Transforming an Actor

To transform an actor or one of its nodes, click on the “Transforms” tab. Select an actor or its node from the lists above the tabs, select whether the transforms should happen in local or world coordinate systems, and finally select the transform which is to be performed.

### Hiding an Actor or a Node

Click on the “Other” tab. Select the actor or a node from the drop-down lists above the tabs that are to be hidden and click on the “Hide Object” button. To show an actor or a node that has been previously hidden, select it from the drop-downs and click on the “Show Object” button.

### Attaching One Actor to the Node of Another

Click on the “Other” tab. Select the actor which is to be attached from the drop-down lists above the tabs. Even if a specific node is selected, the entire actor will be affected. On the drop-down on the bottom of the screen, select the actor and the node to act as the new parent and click on “Attach”. If an actor previously attached to another is to be detached, attach the child actor to “(world)”.

### Rotational Jitter Correction of Scene Graph Nodes For a 3D/2D Animation Engine

Individual characters or figures are modeled by a 3D scene graph hierarchy, with each graph node possessing six degrees of freedom (three positional, three rotational). The world position and orientation of each node can be computed at any given moment in time by concatenating the 4×4 transformation matrices of the node with those of its ancestors. The position and orientation of a node within an active viewport, taking into account the active camera position and perspective foreshortening effect, can be obtained via additional transformations and arithmetic operations. For efficiency, the 4×4 world-to-view matrix is usually combined with the local-to-world transformation.

When the Ingeeni Adapter system is used with a 2D animation-rendering engine (e.g., the Macromedia Flash system), the scene graph of each visible character is traversed during each frame update cycle. For each node, up to three Euler angles (Euler angles are commonly referred to by various names such as “roll, pitch, and yaw”) of the resultant orientation in the active view are used as indices into the set of physical animation assets representing the given <scene graph node, activity> pair. The result of the lookup is a reference to a sequence of animated frame assets, which are then rendered by an animation engine (which can be a commercial tool such as the Macromedia Flash player). The Ingeeni graphics adapter provides the rendering engine with the screen coordinates and scaled size of each animation sequence, so that the positional coordinates and display sizes of the displayed sequences are theoretically correct to within single-precision floating point error. However, since a limited number of physical animation sequences will be provided for a given <scene graph node, activity> pair, the rendered animation only visually approximates the rotational orientation implied by the underlying scene graph.

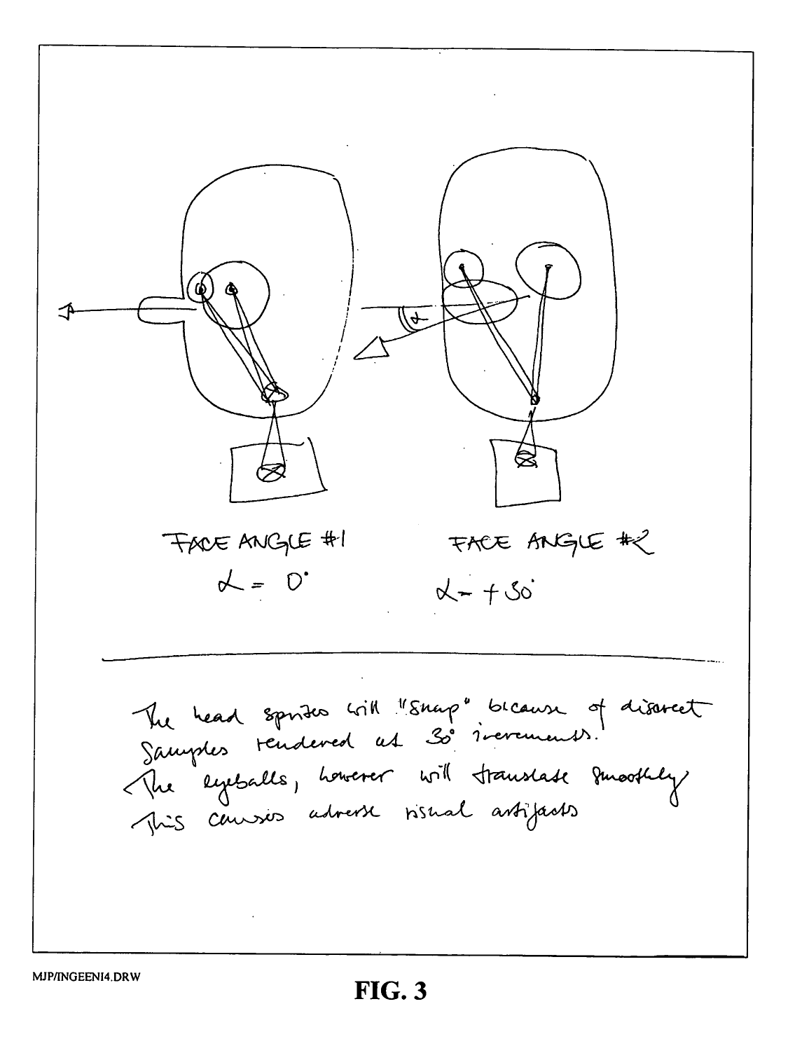

When a character rendered in the manner just described is continuously panned or otherwise rotated, visually objectionable artifacts can occur between adjacent nodes of its scene graph (for example, the head and either eye). Suppose a character's head (FIG. 3) is slowly turning from left to right while its eyes stare straight ahead relative to its face. The rendered animations for the head and each eye will be changed approximately every <nn> and <pp> degrees, respectively, where <nn> and <pp> correspond to the sampling rates provided by the head and eye animation assets. The orientation of the rotating head may be updated several times by application or game engine logic while its rendered animation is sequence held fixed, because of the sampling granularity. Using a naive approach, the graphics adapter would select and position animations for each level of the scene graph independently of one another, so the animation mapping for each eye node would not make use of the fact that the animation of their parent node (the head) had not changed from the previous display frame. The world position and orientation of each eye would then be computed by concatenating the transform representing its position and orientation relative to the head (which by assumption remains constant during this activity) with the transform of its ancestor nodes (represented by the head, which is panning continuously to the right). In general, this would result in changes to both the world position and orientation of each eye from frame to frame, which are carried forward through the view and perspective transformations. As a result, the positions of the eyes are updated more frequently than the orientation of the head, and the eyes appear to jiggle in tiny movements. This is surprising and unsettling, since the positions and orientations the eyes are expected to remain fixed relative to the head during this particular activity.

The solution invented by Ingeeni involves the 2D graphics adapters (e.g., the Flash engine) maintaining essentially two local transforms for each interior node of a scene graph which is represented by a rotationally discrete set of animations; an “uncorrected” transform corresponding to the conventional 3D scene graph implementation, and a jitter-corrected transform. The jitter-corrected transform represents the sampled orientation as currently rendered by the animation engine; during a panning activity, for example, the jitter-corrected transform will remain fixed until the node's indexed 2D animation changes. Since only rotational jitter is being considered here, the jitter correction can be conveniently stored as a set of three Euler angles, or three Euler angular offsets relative to the uncorrected node transform; an equivalent 4×4 jitter-corrected transform can then be computed on the fly.

The 2D graphics adapter (e.g., the Flash engine) allows the game engine to deal exclusively with the uncorrected set of transforms, so that each scene graph node appears to have fine-grained rotational granularity, up to the limits of floating point precision. The uncorrected orientation is used for all high-level game logic such as path-finding, collision avoidance, etc. During the frame update cycle, the uncorrected 4×4 transform for each node is also used when selecting the appropriate 2D animation sequence for the node itself. To perform the rendering calculations, however, the node's local transform must be concatenated with those of its ancestors in the scene graph hierarchy to obtain a full transformation to world coordinates. It is the jitter-corrected transform which is used for each ancestor node during this calculation. Using the earlier example, the calculation of the position and orientation of each eye will concatenate the local orientation of the eye (fixed, staring straight ahead) with the jitter-corrected (discrete, sampled) head orientation.

The result is that changes to the rotational orientations of interior scene graph nodes do not cascade to affect the positions and orientations of their children, until the 2D animation sequences of the interior nodes have been updated as well. This avoids the rotational jitter artifact involving nodes on adjacent layers of a scene graph described earlier.

1. A method for presenting graphics to a user, said method comprising:
(1) providing a 3D graphics system comprising a 3D graphics environment and at least one virtual object positioned in the 3D graphics environment, wherein the 3D graphics system is configured to use 3D mathematics;
(2) providing a 2D graphics rendering engine configured to use 2D mathematics, and providing a library of sprites for use by the 2D graphics rendering engine, wherein for each sprite in the library, there is provided an array of rendered views for that sprite, based on horizontal and vertical angles, with the rendered views being expressed in 2D mathematics;
(3) selecting a camera perspective within the 3D graphics environment;
(4) based on the selected camera perspective, generating an appropriate 2D view of the 3D graphics environment;
(5) based on the generated 2D view, selecting an appropriate sprite and, for that sprite, the appropriate rendered view for that sprite;
(6) determining the appropriate screen location and scale for the selected rendered view for the sprite; and
(7) instructing the 2D graphics rendering engine to paint the selected rendered view for the sprite to the determined screen location and with the determined scale.

2. A method according to claim 1 wherein, after Steps 1 and 2, and before Step 4, updating the 3D graphics environment.

3. A method according to claim 2 wherein the updating is in response to an input event.

4. A method according to claim 1 wherein Step 5 includes interpolating between rendered views so as to generate a more accurate rendered view for that sprite, and using that more accurate rendered view in Steps 6 and 7.

5. A method according to claim 1 wherein said virtual object comprises an animated character.

6. A method according to claim 1 wherein the 2D graphics engine utilizes 2D vector graphics.

7. A method according to claim 1 wherein said 2D graphics rendering engine comprises the Macromedia Flash engine.

8. A method according to claim 1 wherein the step of generating an appropriate 2D view of the 3D graphics environment is effected using C++.

9. A method according to claim 1 wherein Steps 2-7 are effected by a software interface interposed between the 3D graphics system and the 2D graphics rendering engine.

10. A method according to claim 9 wherein the software interface is implemented as a C++ application on top of the 2D graphics rendering engine.

11. A method according to claim 10 wherein the software interface communicates with the 2D graphics rendering engine using Macromedia's C++ API.

12. A method according to claim 11 wherein the software interface writes into the 2D graphics rendering engine using Macromedia's setVariable( ) function.

13. A software interface interposed between a 3D graphics system and a 2D graphics rendering engine for use in presenting graphics to a user,
wherein the 3D graphics system comprises a 3D graphics environment and at least one virtual object positioned in the 3D graphics environment, and wherein the 3D graphics system is configured to use 3D mathematics, and
wherein the 2D graphics rendering engine is configured to use 2D mathematics, and wherein the 2D graphics rendering engine is provided with a library of sprites for use by the 2D graphics rendering engine, and further wherein for each sprite in the library, there is provided an array of rendered views for that sprite, based on horizontal and vertical angles, with the rendered views being expressed in 2D mathematics;
the software interface comprising:
a first element for selecting a camera perspective within the 3D graphics environment;
a second element for generating an appropriate 2D view of the 3D graphics environment based on the selected camera perspective;
a third element for selecting, based on the generated 2D view, an appropriate sprite and, for that sprite, the appropriate rendered view for that sprite;
a fourth element for determining the appropriate screen location and scale for the selected rendered view for the sprite; and
a fifth element for instructing the 2D graphics rendering engine to paint the selected rendered view for the sprite to the determined screen location and with the determined scale.

14. A software interface according to claim 12 wherein the software interface further comprises a sixth element for updating the 3D graphics environment.

15. A software interface according to claim 14 wherein the updating is in response to an input event.

16. A software interface according to claim 12 wherein the third element is configured to interpolate between rendered views so as to generate a more accurate rendered view for that sprite, and wherein the more accurate rendered is used in the fourth and fifth elements.

17. A software interface according to claim 12 wherein said virtual object comprises an animated character.

18. A software interface according to claim 12 wherein the 2D graphics engine utilizes 2D vector graphics.

19. A software interface according to claim 18 wherein said 2D graphics rendering engine comprises the Macromedia Flash engine.

20. A software interface according to claim 12 wherein the second element is implemented in C++.

21. A software interface according to claim 12 wherein the software interface is implemented as a C++ application on top of the 2D graphics rendering engine.

22. A software interface according to claim 12 wherein the software interface communicates with the 2D graphics rendering engine using Macromedia's C++ API.

23. A software interface according to claim 12 wherein the software interface writes into the 2D graphics rendering engine using Macromedia's setVariable( ) function.

24. A graphics system comprising:
a 3D graphics system comprising a 3D graphics environment and at least one virtual object positioned in the 3D graphics environment, wherein the 3D graphics system is configured to use 3D mathematics;
a 2D graphics rendering engine configured to use 2D mathematics, and a library of sprites for use by the 2D graphics rendering engine, wherein for each sprite in the library, there is provided an array of rendered views for that sprite, based on horizontal and vertical angles, with the rendered views being expressed in 2D mathematics; and
a software interface interposed between the 3 D graphics system and the 2D graphics system;
the software interface comprising:
a first element for selecting a camera perspective within the 3D graphics environment;
a second element for generating an appropriate 2D view of the 3D graphics environment based on the selected camera perspective;
a third element for selecting, based on the generated 2D view, an appropriate sprite and, for that sprite, the appropriate rendered view for that sprite;
a fourth element for determining the appropriate screen location and scale for the selected rendered view for the sprite; and
a fifth element for instructing the 2D graphics rendering engine to paint the selected rendered view for the sprite to the determined screen location and with the determined scale.

25. A graphics system according to claim 24 wherein the software interface further comprises a sixth element for updating the 3D graphics environment.

26. A graphics system according to claim 25 wherein the updating is in response to an input event.

27. A graphics system according to claim 25 wherein the third element is configured to interpolate between rendered views so as to generate a more accurate rendered view for that sprite, and wherein the more accurate rendered is used in the fourth and fifth elements.

28. A graphics system according to claim 24 wherein said virtual object comprises an animated character.

29. A graphics system according to claim 24 wherein the 2D graphics engine utilizes 2D vector graphics.

30. A graphics system according to claim 29 wherein said 2D graphics rendering engine comprises the Macromedia Flash engine.

31. A graphics system according to claim 24 wherein the second element is implemented in C++.

32. A graphics system according to claim 24 wherein the software interface is implemented as a C++ application on top of the 2D graphics rendering engine.

33. A graphics system according to claim 24 wherein the software interface communicates with the 2D graphics rendering engine using Macromedia's C++ API.

34. A graphics system according to claim 24 wherein the software interface writes into the 2D graphics rendering engine using Macromedia's setVariable( ) function.

35. An interactive character system as disclosed herein.

36. A method for communicating between Flash and C++ as disclosed herein.

37. An entertainment system as disclosed herein.

38. A method for creating content as disclosed herein.

39. A method for communicating between any 2D (two-dimensional graphics package) and C++ as disclosed herein.
